(19) United States
(12) Patent Application Publication
(10) Pub. No.: US 2005/0241642 A1
(43) Pub. Date: Nov. 3, 2005

(54) Breathing respirator

(76) Inventor: J. Mario Krzysztofik, Montgomery Village, MD (US)

Correspondence Address: Richard C. Litman;LITMAN LAW OFFICES, LTD., P.O. Box 15035, Arlington, VA, 22215, US

(21) Appl. No.: 10/986,209

(22) Filed: Nov. 12, 2004

Related U.S. Application Data
(60) Provisional application No. 60/518,628, filed on Nov. 12, 2003.

(51) Int. Cl. A62B 18/08; A62B 23/02

(52) U.S. Cl. 128/206.15

(57) ABSTRACT

The combination noise suppression and breathing respirator of the present invention includes a face mask of the snorkel or diving type, the facemask sealing against the face of the user around the nose, cheeks, eyes and forehead of the wearer. The facemask has a nosepiece having an exhalation flap check valve for exhalation by the user. Each side of the face mask has a one-way inlet valve at a connection which connects with rearward extending dual use air channel and straps. A noise suppression and air filter module is worn over each ear of the user and is attached to respective dual use air channel and straps. Head bands extend around the back of the wearer's head between air filter modules an adjustably connected by buckles thereto.

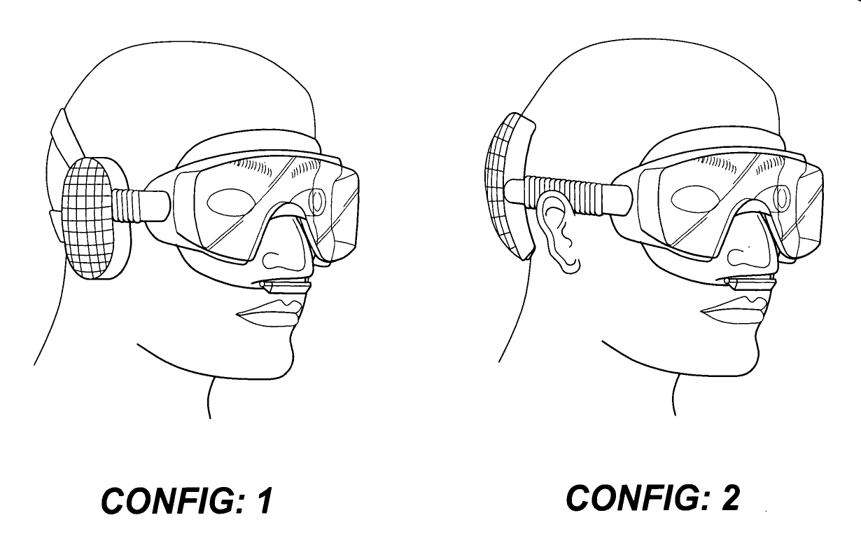

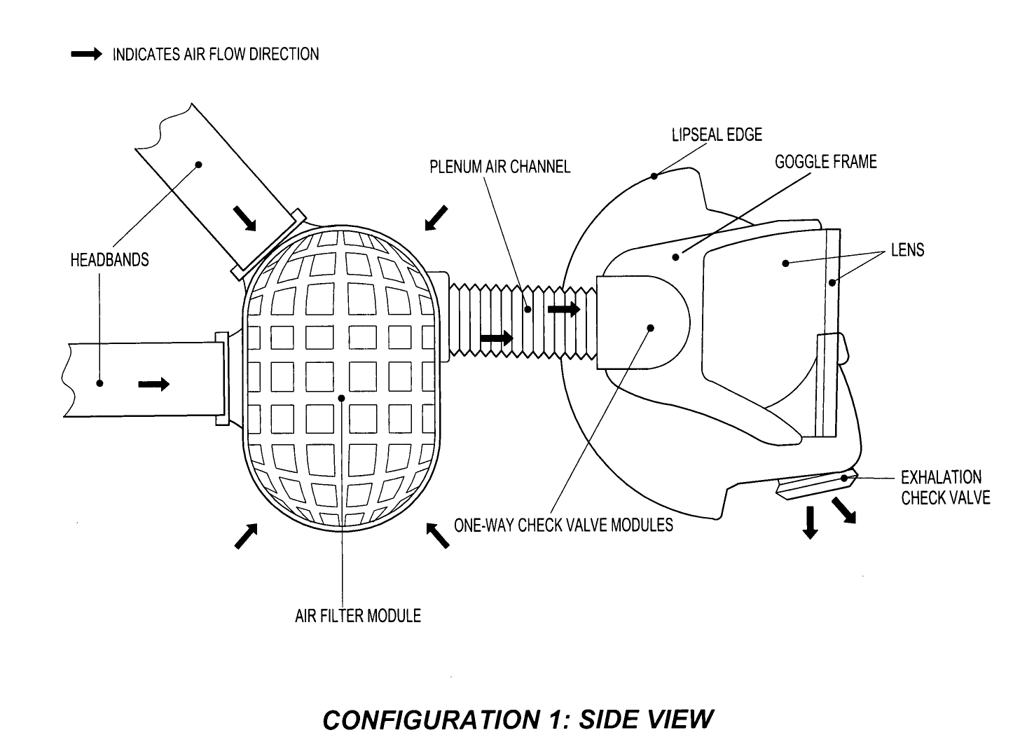

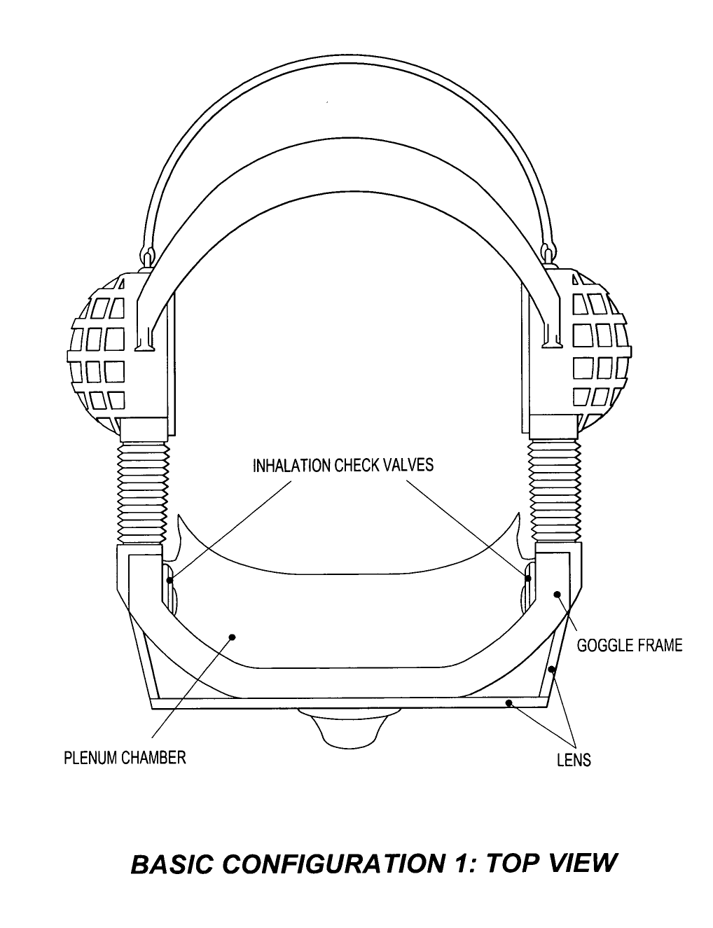

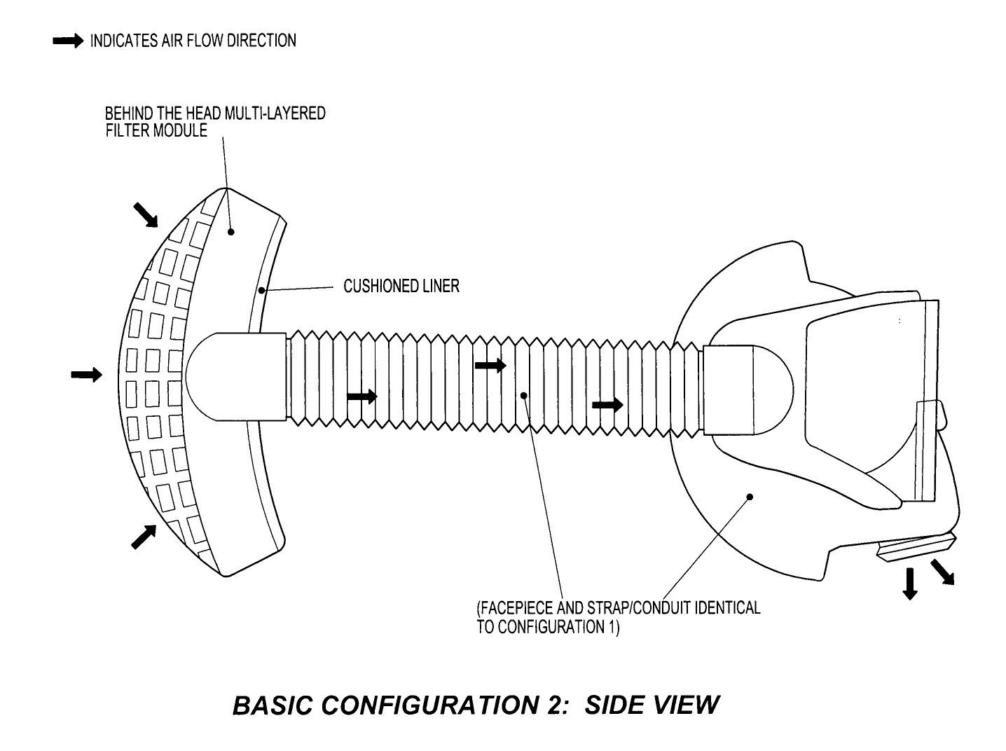

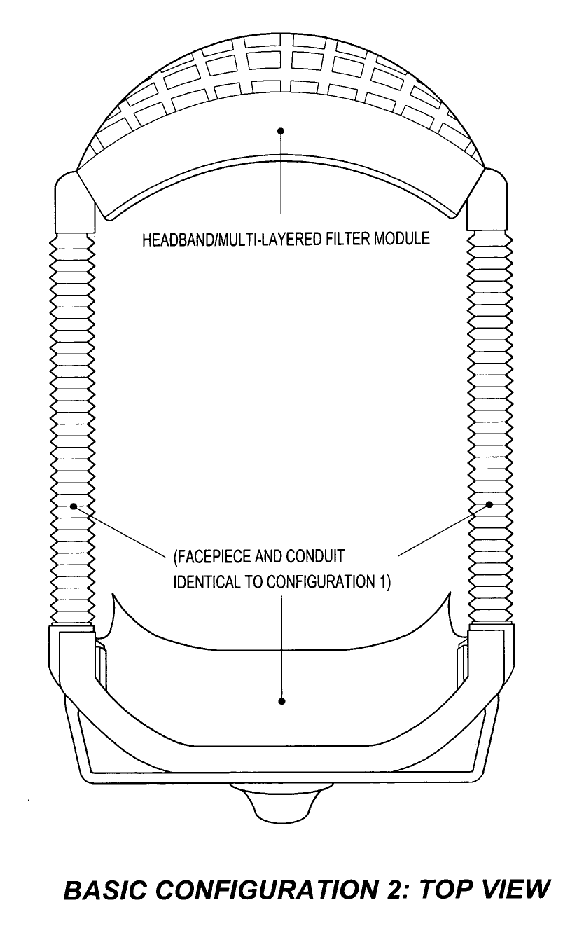

### CROSS-REFERENCE TO RELATED APPLICATION

This application claims the benefit of U.S. Provisional Patent Application Ser. No. 60/518,628 filed Nov. 12, 2003.

### TECHNICAL DESCRIPTION

### HOW IT WORKS

As observed in the accompanying drawings of the Breathing Respirator (hereafter, for brevity, the breathing respirator/apparatus will be referred to as the BR), normal breathing draws clean air through filters into the eye/nose plenum chamber of the facepiece. The constant air renewal creates an efficient defogging action which keeps the lens completely clear. Inhalation and exhalation one-way check valves ensure constant flow in one direction without backflow.

### IT'S NOVELTY

It's novelty resides in radical changes over existing BR. First, the relocation of the filter elements from the front of the mouthpiece, to either behind the head or integrated with noise reduction ear muffs, allows for a sleeker, smaller, light-weight supporting facepiece free of obstructing elements in front of the face. Second, and most important, it leaves the mouth free of constraints of current BR. Unlike almost all existing BR on the market, this feature allows unimpeded speech in a normal way without the need of electronically assisted communication capabilities, as in some current models. This alone constitutes a breakthrough, since the wearer of the BR is allowed normal conversation with others, without removing the facepiece, even when using cell phones, 2-way radios, etc. Third, the circulation of air created within the facepiece, through normal breathing, keeps the lens fog and mist free at all outside temperatures. This is a major drawback on existing goggles and full facepiece BR, that has been addressed by adding such gadgets as bulky, battery-driven electric fans to usually only reduce fogging. In my BR, normal breathing remedies this problem, by not just reducing, but eliminating fogging. Fourth, by relocating the filter elements to other places, like in one of the models show, behind the head, a wider filtering area can be obtained. This allows a thinner and still efficient filter that can be worn under a hard hat, helmet, etc. Fifth, since the us of a BR and eye protection go hand-in-hand (whenever the use of a BR is mandatory, safety goggles are as well), a device that envelops eyes and nose is fundamental. This is paramount whenever multiple safety devices (eye protection, noise reduction, respirator, hard hat, etc.) are required. Since these are built in a single-purpose units, the simultaneous wearing of two or more is almost impossible, or extremely uncomfortable and cumbersome, because the devices themselves and their mounting straps overlap each other. My BR incorporates eye protection, safe breathing, and noise reduction, all in one comfortable, sleek unit, which can still be worn under additional equipment such as a hard hat. Again, my novell invention allows for designs that tackle all hazardous situations in one practical and elegant way. The only perceived drawback is that it can only be used properly by persons who breathe through their nose normally, who constitute the majority.

### HOW IT WOULD BE PRODUCED/MANUFACTURED

Prototype units in different configurations have been built, tested and evaluated as proof of concept.

Pre-production demonstrator units to validate various designs can be produced employing stereolithography for the main frame, plus shop fabricated components where needed. Choices of materials depend on the configuration and specific application of the BR. For large quantities, outsourcing appears as the best option, given the nature of the components. State-of-the-art manufacturing facilities specialized in different dual durometer injection molding of hypoallergenic thermoplastic elastomers, fluoroelastomers, etc. are ideal. Same for extruded parts and miscellaneous hardware. A plant for integration of components, packaging, and distribution should suffice at the initial stage.

### WHERE IT COULD BE APPLIED

Although the BR was conceived to cope with the needs arisen from the tragic 9-11 events, as an easy to use, don and wear emergency BR for evacuating buildings under fire or biochemical threat, and still retain the ability to communicate with other people and rescue crews, the obvious advantages of this new design found applications in multiple fields. It can almost be claimed that this is a solution looking for a problem. Applications include:
Fire escape: filter behind head, cap style, oxygen supply possible
Skiing: anti-fogging, air drawn from heat exchanger Bicycling: integrated with helmet, air warmer if needed
High mountain climbing: air warmer, oxygen supply
industrial safety: particulates/fume/dust/organic vapors filtering, with noise muffler incorporated
Construction/public works: incorporated with hard hat
Military: incorporated with current issue Kevlar helmet, communications integration, biochemical hazards capable
U.S. Post Office mail handlers: dust/anthrax filter
Mining: incorporated high intensity discharge xenon lamps/LED lamps, oxygen reserve
Jogging: smog filters, air warmer, MP-3 player integrated with ear muffs
Simple goggles face mask without filters: defogging action only, wide array of use
Without check valves, with external air supply: for paint shops, etc.

### POTENTIAL BENEFITS

These lie in a BR that offer personal comfort and fashionable appearance, while still retaining it's utility function. With the fact that speaking freely, eating, drinking, even smoking, etc. can all be done while wearing the BR, makes it far more appealing to people that also have to wear it when required by law or other needs or requirements. Also, it's unique features make it appealing to seek certification under the U.S. Canter for Disease Control (CDC) and National Institute for Occupational Safety and Health (NIOSH) Program for a self-contained breathing apparatus (SCBA).

The only device that has an eye/nose plenum face piece is the scuba diving mask. This mask is designed so you cannot breathe through your nose, my mask is designed so you can breathe through your nose. The functions are diametrically opposed.

I am seeking the utility patent due to the principle and function of my mask. The two that are shown including anything else that is listed. The changes are not cosmetic and therefore qualifies for a utility patent.

I further contemplate the following additions:
1) A configuration that has the filter mounted on the back of the head, conventional noise reduction earcups attached to the facemask
2) A configuration that has a facemask that covers nose and mouth and may include features of the other configurations

1. A combination hearing protector and breathing respirator, comprising:
a face mask having a front lens having a side lens on each side thereof, a face conforming sealing body having a nose conforming portion, a frame supporting said lenses and said sealing body, an exhalation flap check valve located on said nose portion, and a supporting frame for supporting said lenses and said sealing body, said frame having opposed side portions, and a one-way check valve module located in each of said frame side portions; said face mask defining a plenum chamber between said face mask and the face of the user;
a dual purpose air channel and facemask strap connected with each of said frame side portions and extending rearward therefrom, each said air channel being in one-way fluid communication with said plenum chamber through said one-way check valve modules;
a pair of air filter and noise reduction modules each having a sealing frame for sealing over the respective ears of the user, an air inlet grid extending outward from said sealing frame, said sealing frame having outlet air channel connections connected with said rearward extending dual purpose air channel and facemask straps, said air inlet grid being in fluid communication through said outlet air channels and thus said dual purpose air channel and facemask straps; said sealing frame having rearward mounted buckles; and
a head band extending between said sealing frame buckles for extending around the back of the user's head;
whereby noise suppression is accomplished by said air filter and noise suppression modules when worn by a user; and
whereby air for breathing through the use's nose travels through said air filter and noise suppression modules, said dual purpose air channel and facemask straps, said one-way check valves, and into said plenum chamber upon breathing in by the user, and exhausted breath exits said plenum chamber through said nose portion mounted exhalation flap check valve upon exhalation by the user.

2. The combination hearing protector and breathing respirator, of claim 1, said noise suppression filter module having a layered paper filtration medium.
